(19) United States
(12) Patent Application Publication
(10) Pub. No.: US 2026/0172946 A1
(43) Pub. Date: Jun. 18, 2026

(54) TECHNIQUES TO INDICATE UPDATES TO WIRELESS PARAMETERS

(71) Applicant: QUALCOMM Incorporated, San Diego, CA (US)

(72) Inventors: Abhishek Pramod PATIL, San Diego, CA (US); Gaurang NAIK, San Diego, CA (US); Alfred ASTERJADHI, San Diego, CA (US); George CHERIAN, San Diego, CA (US); Sai Yiu Duncan HO, San Diego, CA (US); Sanket Sanjay KALAMKAR, San Diego, CA (US); Giovanni CHISCI, San Diego, CA (US); Sherief HELWA, San Diego, CA (US)

(21) Appl. No.: 18/981,296

(22) Filed: Dec. 13, 2024

(51) Int. Cl. H04W 48/08

(52) U.S. Cl. CPC H04W 48/08

(57) ABSTRACT

This disclosure provides methods, components, devices and systems for techniques to indicate updates to wireless parameters. Some aspects more specifically relate to a frame that includes improved update indications. Some aspects more specifically relate to the frame including a first indication of a first generation (e.g., whether an access point (AP) is a Ultra High Reliability (UHR) or later generation or pre-UHR generation AP) of a wireless network supported by the AP that transmits the frame, a second indication that there is an update to at least one parameter of the wireless network, and a third indication of the earliest generation for which the update is applicable. In some examples, these three indications may be carried in an early portion of the frame.

### TECHNICAL FIELD

This disclosure relates generally to wireless communication and, more specifically, to techniques to indicate updates to wireless parameters.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications at a wireless node is described. The method may include obtaining a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network and obtaining, based on the third indication, information associated with the update to the at least one first parameter.

An apparatus for wireless communications is described. The apparatus may include one or more processing systems that include processor circuitry and memory circuitry that stores code. The one or more processing systems may be configured to cause the apparatus to obtain a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network and obtain, based on the third indication, information associated with the update to the at least one first parameter.

Another apparatus for wireless communications is described. The apparatus may include means for obtaining a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network and means for obtaining, based on the third indication, information associated with the update to the at least one first parameter.

A non-transitory computer-readable medium storing code for wireless communications is described. The code may include instructions executable by one or more processors to obtain a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network and obtain, based on the third indication, information associated with the update to the at least one first parameter.

In some examples of the method, apparatus, and non-transitory computer-readable medium described herein, the first indication may be included in a capability information field of the frame and the third indication may be included in the capability information field of the frame.

In some examples of the method, apparatus, and non-transitory computer-readable medium described herein, the first indication may be included in bit B2 of the capability information field and the third indication may be included in bits B3, B14, or B15 in the capability information field.

In some examples of the method, apparatus, and non-transitory computer-readable medium described herein, the first indication may be included in a traffic indication map field of the frame and the third indication may be included in the traffic indication map field of the frame.

In some examples of the method, apparatus, and non-transitory computer-readable medium described herein, the frame includes a beacon frame and the third indication may be included in bits B50, B51, or B52 in the traffic indication map field.

In some examples of the method, apparatus, and non-transitory computer-readable medium described herein, the early portion of the frame further includes a fourth indication that there may be a second update to a second parameter associated with a second generation of the wireless network, the second generation satisfying a threshold and the information further includes a fifth indication of a parameter change count associated with the second generation, the fifth indication being included in a later portion of the frame that follows the early portion.

In some examples of the method, apparatus, and non-transitory computer-readable medium described herein, the information further includes a fourth indication of a parameter change count associated with a second generation of the wireless network, the second generation satisfying a threshold, the fourth indication being included in a later portion of the frame that follows the early portion and each of the first indication and the fourth indication includes a non-zero value to indicate a second update to a second parameter associated with the second generation.

In some examples of the method, apparatus, and non-transitory computer-readable medium described herein, the first indication may be associated with the access point associated with a transmitted basic service set identifier (TxBSSID).

In some examples of the method, apparatus, and non-transitory computer-readable medium described herein, the information further includes a fourth indication of a second generation of the wireless network that may have at least one updated parameter associated with a second access point associated with a non-transmitted basic service set identifier (nonTxBSSID), the second generation satisfying a threshold.

In some examples of the method, apparatus, and non-transitory computer-readable medium described herein, the fourth indication may be conveyed via three bits in a nontransmitted BSSID capability element.

In some examples of the method, apparatus, and non-transitory computer-readable medium described herein, the information may be included in the frame.

In some examples of the method, apparatus, and non-transitory computer-readable medium described herein, the early portion of the frame further includes a fourth indication that one or more updated parameters may be included in the frame.

In some examples of the method, apparatus, and non-transitory computer-readable medium described herein, the information may be included in a second frame different than the frame.

Some examples of the method, apparatus, and non-transitory computer-readable medium described herein may further include operations, features, means, or instructions for outputting a query frame after obtaining the frame, where the information may be obtained via a response frame and after outputting the query frame.

In some examples of the method, apparatus, and non-transitory computer-readable medium described herein, the query frame includes a probe request frame and the response frame includes a probe response frame.

In some examples of the method, apparatus, and non-transitory computer-readable medium described herein, the response frame includes a physical layer protocol data unit (PPDU) format associated with a second generation of the wireless network, the second generation satisfying a threshold.

In some examples of the method, apparatus, and non-transitory computer-readable medium described herein, the query frame may be output via a link indicated by the access point.

In some examples of the method, apparatus, and non-transitory computer-readable medium described herein, the early portion of the frame includes a traffic indication map field and fields that come before the traffic indication map field.

In some examples of the method, apparatus, and non-transitory computer-readable medium described herein, the frame may be configured as a beacon frame.

In some examples of the method, apparatus, and non-transitory computer-readable medium described herein, the at least one first parameter may be as a basic service set (BSS) parameter.

In some examples of the method, apparatus, and non-transitory computer-readable medium described herein, the at least one first parameter may be associated with a second generation of the wireless network, the second generation satisfying a threshold.

Some examples of the method, apparatus, and non-transitory computer-readable medium described herein may further include operations, features, means, or instructions for updating the at least one updated parameter included in the third indication after obtaining the third indication.

A method for wireless communications at a wireless node is described. The method may include outputting a frame including an early portion, the early portion of the frame including a first indication of a first generation of a wireless network implemented by the apparatus associated with the frame, a second indication that there is an update to at least one first parameter associated with at least one generation of the wireless network, and a third indication of at least an earliest generation that has at least one updated parameter, the earliest generation associated with the wireless network and outputting, based on the third indication, information associated with the update to the at least one first parameter.

An apparatus for wireless communications is described. The apparatus may include a processing system that includes processor circuitry and memory circuitry that stores code. The processing system may be configured to cause the apparatus to output a frame including an early portion, the early portion of the frame including a first indication of a first generation of a wireless network implemented by the apparatus, a second indication that there is an update to at least one first parameter associated with at least one generation of the wireless network, and a third indication of at least an earliest generation that has at least one updated parameter, the earliest generation associated with the wireless network and output, based on the third indication, information associated with the update to the at least one first parameter.

Another apparatus for wireless communications is described. The apparatus may include means for outputting a frame including an early portion, the early portion of the frame including a first indication of a first generation of a wireless network implemented by the apparatus, a second indication that there is an update to at least one first parameter associated with at least one generation of the wireless network, and a third indication of at least an earliest generation that has at least one updated parameter, the earliest generation associated with the wireless network and means for outputting, based on the third indication, information associated with the update to the at least one first parameter.

A non-transitory computer-readable medium storing code for wireless communications is described. The code may include instructions executable by one or more processors to output a frame including an early portion, the early portion of the frame including a first indication of a first generation of a wireless network implemented by an apparatus associated with the frame, a second indication that there is an update to at least one first parameter associated with at least one generation of the wireless network, and a third indication of at least an earliest generation that has at least one updated parameter, the earliest generation associated with the wireless network and output, based on the third indication, information associated with the update to the at least one first parameter.

In some examples of the method, apparatus, and non-transitory computer-readable medium described herein, the first indication may be included in a capability information field of the frame and the third indication may be included in the capability information field of the frame.

In some examples of the method, apparatus, and non-transitory computer-readable medium described herein, the first indication may be included in bit B2 of the capability information field and the third indication may be included in bits B3, B14, or B15 in the capability information field.

In some examples of the method, apparatus, and non-transitory computer-readable medium described herein, the first indication may be included in a traffic indication map field of the frame and the third indication may be included in the traffic indication map field of the frame.

In some examples of the method, apparatus, and non-transitory computer-readable medium described herein, the frame includes a beacon frame and the third indication may be included in bits B50, B51, or B52 in the traffic indication map field.

In some examples of the method, apparatus, and non-transitory computer-readable medium described herein, the early portion of the frame further includes a fourth indication that there may be a second update to a second parameter associated with a second generation of the wireless network, the second generation satisfying a threshold and the information further includes a fifth indication of a parameter change count associated with the second generation, the fifth indication being included in a later portion of the frame that follows the early portion.

In some examples of the method, apparatus, and non-transitory computer-readable medium described herein, the information further includes a fourth indication of a parameter change count associated with a second generation of the wireless network, the second generation satisfying a threshold, the fourth indication being included in a later portion of the frame that follows the early portion and each of the first indication and the fourth indication includes a non-zero value to indicate a.

In some examples of the method, apparatus, and non-transitory computer-readable medium described herein, the first indication may be associated with the apparatus associated with a transmitted basic service set identifier (TxBSSID).

In some examples of the method, apparatus, and non-transitory computer-readable medium described herein, the information further includes a fourth indication of a second generation of the wireless network that may have at least one updated parameter associated with a second apparatus associated with a non-transmitted basic service set identifier (nonTxBSSID), the second generation satisfying a threshold.

In some examples of the method, apparatus, and non-transitory computer-readable medium described herein, the fourth indication may be conveyed via three bits in a nontransmitted BSSID capability element.

In some examples of the method, apparatus, and non-transitory computer-readable medium described herein, the information may be included in the frame.

In some examples of the method, apparatus, and non-transitory computer-readable medium described herein, the early portion of the frame further includes a fourth indication that one or more updated parameters may be included in the frame.

In some examples of the method, apparatus, and non-transitory computer-readable medium described herein, the information may be included in a second frame different than the frame.

Some examples of the method, apparatus, and non-transitory computer-readable medium described herein may further include operations, features, means, or instructions for obtaining a query frame after outputting the frame, where the information may be output via a response frame and after obtaining the query frame.

In some examples of the method, apparatus, and non-transitory computer-readable medium described herein, the query frame includes a probe request frame and the response frame includes a probe response frame.

In some examples of the method, apparatus, and non-transitory computer-readable medium described herein, the response frame includes a physical layer protocol data unit (PPDU) format associated with a second generation of the wireless network, the second generation satisfying a threshold.

In some examples of the method, apparatus, and non-transitory computer-readable medium described herein, the query frame may be output via a link indicated by the apparatus.

In some examples of the method, apparatus, and non-transitory computer-readable medium described herein, the early portion of the frame includes a traffic indication map field and fields that come before the traffic indication map field.

In some examples of the method, apparatus, and non-transitory computer-readable medium described herein, the frame may be configured as a beacon frame.

In some examples of the method, apparatus, and non-transitory computer-readable medium described herein, the at least one first parameter may be as a basic service set (BSS) parameter.

In some examples of the method, apparatus, and non-transitory computer-readable medium described herein, the at least one first parameter may be associated with a second generation of the wireless network, the second generation satisfying a threshold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a pictorial diagram of another example wireless communication network.

FIG. 6 shows a timing diagram illustrating an example process for performing a ranging operation.

FIG. 7 shows an example of signaling diagram that supports techniques to indicate updates to wireless parameters.

FIG. 8 shows an example of a frame body that supports techniques to indicate updates to wireless parameters.

FIG. 9 shows an example of a process flow that supports techniques to indicate updates to wireless parameters.

FIG. 10 shows a block diagram of an example wireless communication device that supports techniques to indicate updates to wireless parameters.

FIG. 11 shows a block diagram of an example wireless communication device that supports techniques to indicate updates to wireless parameters.

FIGS. 12 and 13 show flowcharts illustrating example processes performable by or at an AP that supports techniques to indicate updates to wireless parameters.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may implement various procedures to update devices. For example, access points (APs) may transmit an indication to one or more associated clients (e.g., stations (STAs) or other APs) to indicate that a critical update is available. After transmitting the indication, the access points may provide information for the update itself (e.g., a change to one or more parameters of the wireless networks). In some cases, however, the updates are not applicable to devices based on the capability or generation of the device. In such cases, the client may receive the indication that an update is available, read the information for the update, determine that the information for the update is not applicable (e.g., the update is applicable to later generations), and then resume other operations. Such a client device may utilize significant power and other computing resources (e.g., communication resources, processing resources) to read the update information. As new wireless network generations are increasingly available and as each new generation adds more elements to the critical updates set, critical updates are increasingly frequent. Additionally, other features, such as Extremely High Throughput (EHT) features and client probing as a result of update indications, may further exacerbate these issues.

Various aspects relate generally to supporting a frame that includes improved update indications. Some aspects more specifically relate to the frame including a first indication of a first generation (e.g., whether the AP is a Ultra High Reliability (UHR) or later generation or pre-UHR generation AP) of a wireless network supported by the AP that transmits the frame, a second indication that there is an update to at least one parameter of the wireless network, and a third indication of the earliest generation for which the update is applicable. In some examples, these three indications may be carried in an early portion of the frame (e.g., a broadcast management frame, beacon frame).

Various aspects of the subject matter described in this disclosure can be implemented to realize one or more of the following potential advantages. In some examples, by using a frame with at least the three indications (e.g., in the early portion of the frame) described herein, the described techniques can be used to allow the receiving clients to quickly and efficiently determine whether the update is applicable to the client and whether to read and process later portions of the frame and other frames or communications. These techniques may reduce power and computing resource overhead associated with some critical update procedures. These and other techniques are described in further detail with respect to the figures.

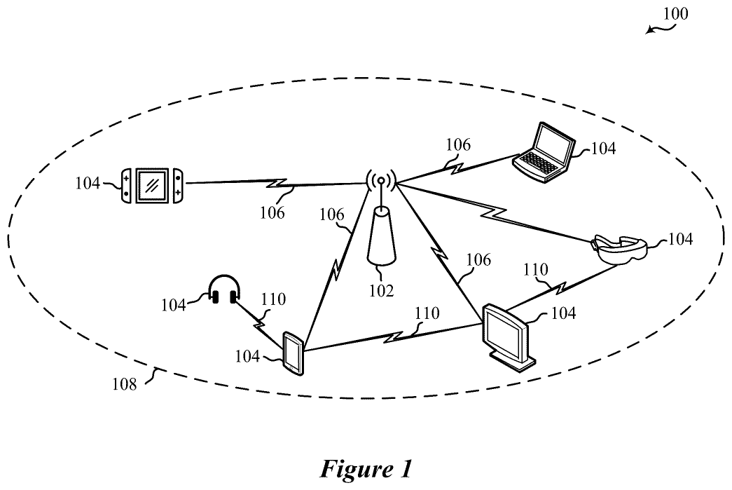

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples. A wireless node may refer to a wireless communication device, such as an AP 102 or a STA 104 that communicates via the wireless communication network 100.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

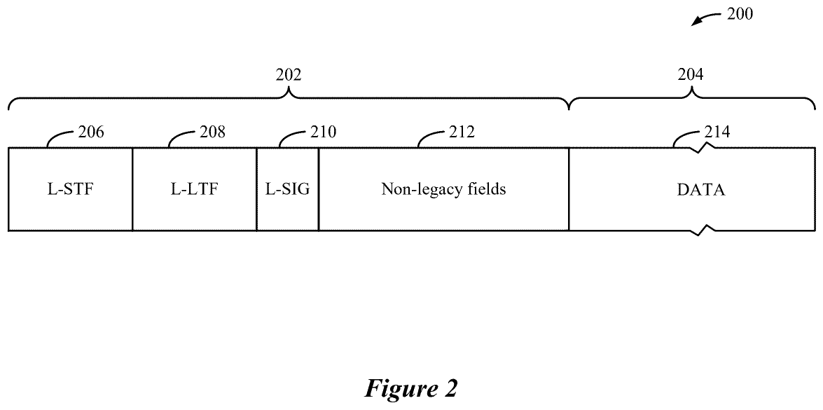

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

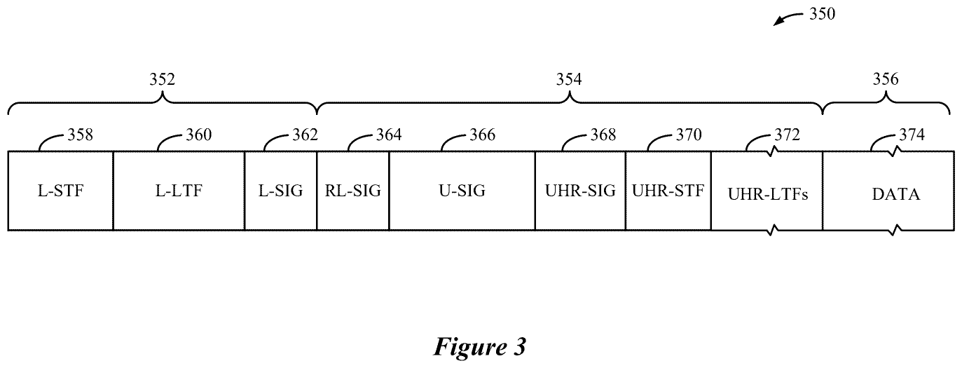

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

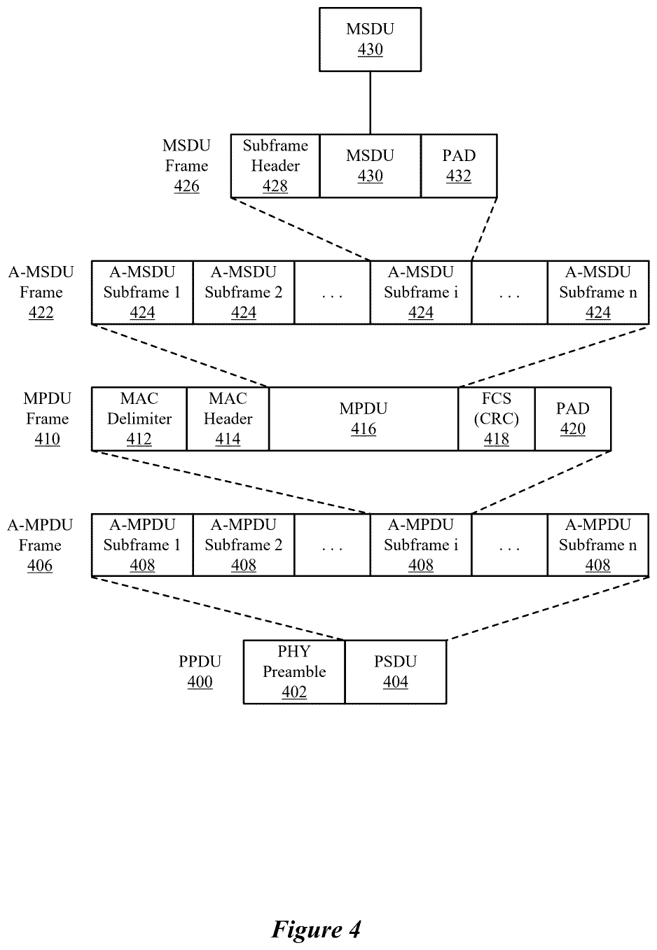

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs after receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

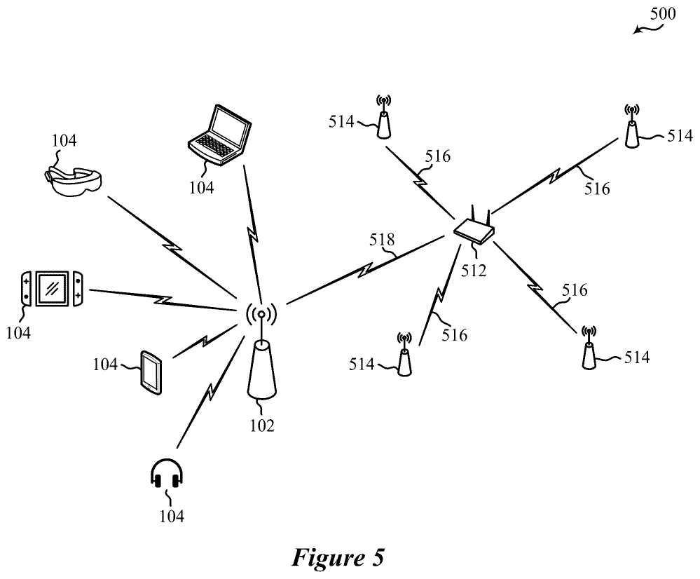

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (for example, audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (for example, cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

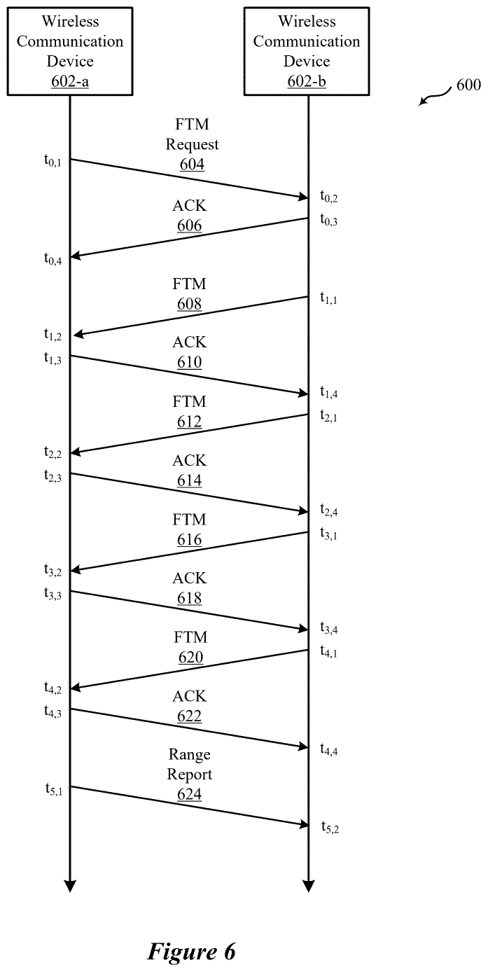

FIG. 6 shows a timing diagram illustrating an example process for performing a ranging operation 600. The process for the ranging operation 600 may be conjunctively performed by two wireless communication devices, such as a first wireless communication device 602-a and a second wireless communication device 602-b, in accordance with the IEEE 802.11REVme standards, which may each be an example of an AP 102 or a STA 104.

The ranging operation 600 may begin with the first wireless communication device 602-a transmitting an initial FTM range request frame 604 at time t_{0,1}. Responsive to successfully receiving the FTM range request frame 604 at time t_{0,2}, the second wireless communication device 602-b responds by transmitting a first ACK 606 at time t_{0,3}, which the first wireless communication device 602-a receives at time t_{0,4}. The first wireless communication device 602-a and the second wireless communication device 602-b exchange one or more FTM bursts, which may each include multiple exchanges of FTM action frames (hereinafter simply “FTM frames”) and corresponding ACKs. One or more of the FTM range request frame 604 and the FTM action frames (hereinafter simply “FTM frames”) may include FTM parameters specifying various characteristics of the ranging operation 600.

In the example shown in FIG. 6, in a first exchange, beginning at time t_{1,1}, the second wireless communication device 602-b transmits a first FTM frame 608. The second wireless communication device 602-b records the time t_{1,1} as the time of departure (TOD) of the first FTM frame 608. The first wireless communication device 602-a receives the first FTM frame 608 at time t_{1,2} and transmits a first acknowledgment frame (ACK) 610 to the second wireless communication device 602-b at time t_{1,3}. The first wireless communication device 602-a records the time t_{1,2} as the time of arrival (TOA) of the first FTM frame 608, and the time t_{1,3} as the TOD of the first ACK 610. The second wireless communication device 602-b receives the first ACK 610 at time t_{1,4} and records the time t_{1,4} as the TOA of the first ACK 610.

Similarly, in a second exchange, beginning at time t_{2,1}, the second wireless communication device 602-b transmits a second FTM frame 612. The second FTM frame 612 includes a first field indicating the TOD of the first FTM frame 608 and a second field indicating the TOA of the first ACK 610. The first wireless communication device 602-a receives the second FTM frame 612 at time t_{2,2} and transmits a second ACK 614 to the second wireless communication device 602-b at time t_{2,3}. The second wireless communication device 602-b receives the second ACK 614 at time t_{2,4}. Similarly, in a third exchange, beginning at time t_{3,1}, the second wireless communication device 602-b transmits a third FTM frame 616. The third FTM frame 616 includes a first field indicating the TOD of the second FTM frame 612 and a second field indicating the TOA of the second ACK 614. The first wireless communication device 602-a receives the third FTM frame 616 at time t_{3,2} and transmits a third ACK 618 to the second wireless communication device 602-b at time t_{3,3}. The second wireless communication device 602-b receives the third ACK 618 at time t_{3,4}. Similarly, in a fourth exchange, beginning at time t_{4,1}, the second wireless communication device 602-b transmits a fourth FTM frame 620. The fourth FTM frame 620 includes a first field indicating the TOD of the third FTM frame 616 and a second field indicating the TOA of the third ACK 618. The first wireless communication device 602-a receives the fourth FTM frame 620 at time t_{4,2} and transmits a fourth ACK 622 to the second wireless communication device 602-b at time t_{4,3}. The second wireless communication device 602-b receives the fourth ACK 622 at time t_{4,4}.

The first wireless communication device 602-a determines (for example, obtains, identifies, ascertains, calculates, or computes) a range indication in accordance with the TODs and TOAs. For example, in implementations or instances in which an FTM burst includes four exchanges of FTM frames, the first wireless communication device 602-a may determine (for example, obtain, identify, ascertain, calculate, or compute) a round trip time (RTT) between itself and the second wireless communication device III02-b in accordance with Equation 1.

$$RTT = \frac{1}{3} ( {\sum }_{k = 1}^{3} {t}_{4 , k} - {\sum }_{k = 1}^{3} {t}_{1 , k} ) - ( {\sum }_{k = 1}^{3} {t}_{3 , k} - {\sum }_{k = 1}^{3} {t}_{2 , k} ) \qquad ( 1 )$$

In some implementations, the range indication is the RTT. Additionally, or alternatively, in some implementations, the first wireless communication device 602-a may determine (for example, obtain, identify, ascertain, calculate, or compute) an actual approximate distance between itself and the second wireless communication device 602-b, for example, by multiplying the RTT by an approximate speed of light in the wireless medium. In such instances, the range indication may additionally, or alternatively, include the distance value. Additionally, or alternatively, the range indication may include an indication as to whether the second wireless communication device 602-b is within a proximity (for example, a service discovery threshold) of the first wireless communication device 602-a in accordance with the RTT. In some implementations, the first wireless communication device 602-a may transmit the range indication to the second wireless communication device 602-b, for example, in a range report 624 at time t_{5,1}, which the second wireless communication device receives at time t_{5,2}.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

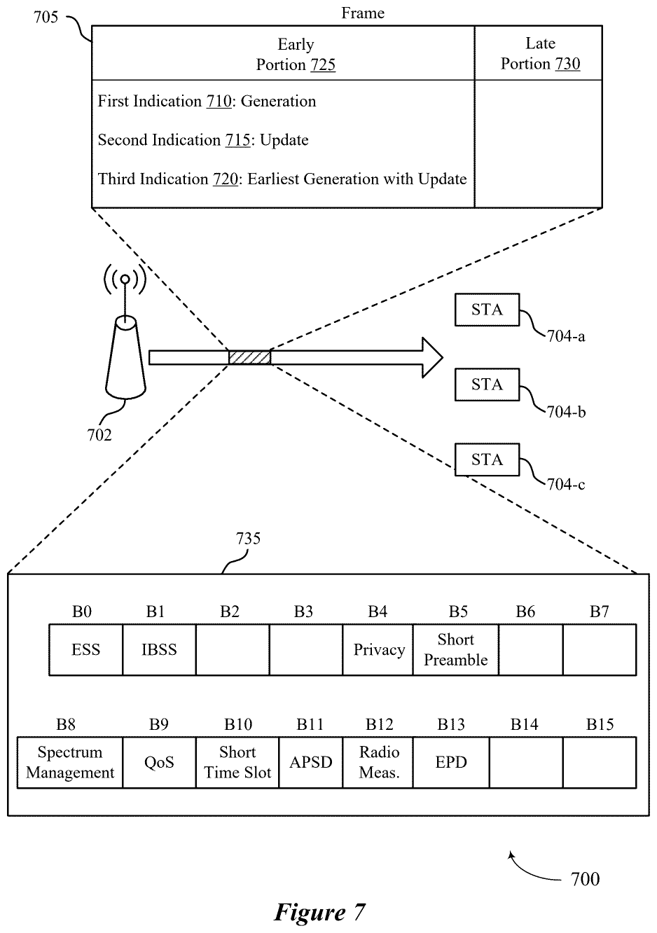

FIG. 7 shows an example of a signaling diagram 700 that supports techniques to indicate updates to wireless parameters. The signaling diagram 700 includes an AP 702, a STA 704-a, a STA 704-b, and a STA704-c. The AP 702 may be an example of the APs as described herein with respect to FIGS. 1 through 6, and the STAs 704 may be examples of the STAs as described herein with respect to FIGS. 1 through 6.

As described herein, APs may utilize one or more signaling techniques to indicate that critical updates are available for clients, such as other APs or the STAs 704. For example, a Check Beacon field in a traffic indication map (TIM) frame of a beacon frame may be incremented each time there is an update to an element listed in a critical element set defined by IEEE standards. The increment may be used to indicate to clients that a critical update may be available for the clients. This common incremental framework may not be different between various Wi-Fi standards generation, and each generation may add more elements to the critical update set, thereby increasing the frequency of updates. As a result, client devices belonging to earlier generations may utilize resources (e.g., power, processing, and communication resources) to read an entire beacon frame (or a large portion thereof) or probing the AP to determine whether the update is applicable to the client devices. In such cases, the client device may determine that there are no changes or critical updates to the parameters supported by the client device (e.g., the update occurred for parameters for a generation later than the one supported by the client device). For example, a 11n device that is in power-save mode may monitor TIM frames. After receiving the TIM frame with the incremented check beacon field, the 11n device may wake-up during target beacon transmission time (TBTT) to receive the beacon frame, but the update may be for an element supported by 11ax devices (e.g., not applicable to the 11n device). As such, the 11n device may utilize resources reading update information that is not applicable to the 11n device.

Moreover, EHT extended the critical updates framework to include multi-link scenarios, which may further aggravate the issues described herein. For example, EHT added an early indication to signal an update to any link of the AP multi-link device (MLD) (AP MLD), a change sequence counter for each link, and an indication of whether the updates for another link are included in the beacon itself, among other information. Some schemes may a seek to address these issues and to address beacon bloating by letting UHR and above APs not include new elements defined by UHR and later generations in the beacon frame. However, such a scheme may lead to probe storm, whereby multiple STAs poll the AP to retrieve a critical update.

Wireless nodes may support multiple versions of a wireless network. For example, wireless nodes may support multiple versions of Wi-Fi. To communicate, wireless nodes typically use a common version of the wireless network. For example, if an AP is communicating with a STA over Wi-Fi, the AP and the STA typically uses a common version of Wi-Fi. In some cases, an AP may support multiple versions and may communicate with different STAs using different versions (e.g., sometimes concurrently). Different versions of the wireless network may differ in formats of frames, radio frequency spectrums occupied, data rates, support of multi-link communications, among other differences. Some wireless networks (e.g., Wi-Fi) may use a generational numbering system to identify what particular version (or versions) of the wireless network a wireless node supports. As used herein, a generation may refer to a version of the wireless network that is associated with the wireless node, the communications between wireless nodes, parameters being updated, or other aspects of the wireless network. In a specific example, Wi-Fi has a number of different generations including: Wi-Fi 0 (corresponding to 802.11), Wi-Fi 1 (corresponding to 802.11b), Wi-Fi 2 (corresponding to 802.11a), Wi-Fi 3 (corresponding to 802.11g), Wi-Fi 4 (corresponding to 802.11n), Wi-Fi 5 (corresponding to 802.11ac), Wi-Fi 6 or 6E (corresponding to 802.11ax), Wi-Fi 7 (corresponding to 802.11be), Wi-Fi 8 (corresponding to 802.11bn), and beyond.

Techniques described herein support a critical update framework where a frame 705 (e.g., a broadcast management frame, beacon frame) may include one or more indications of a generation to which a critical update to a parameter is applicable or occurs. In such cases, if an update is applicable to a later generation, clients that belong to earlier generations may ignore the update information. These techniques may support reduction in power consumption and reduction of the quantity of clients that may query or probe the AP to retrieve the updates. For example, the frame 705 described herein may include a first indication 710 of a first generation (e.g., whether the AP is a UHR or later generation or pre-UHR generation AP) of a wireless network supported by the AP that transmits the frame 705, a second indication 715 that there is an update to at least one parameter of the wireless network, and a third indication 720 of the earliest generation for which the update is applicable. These three indications (among other types of indications described herein) may be carried in an early portion 725 of the frame 705 and may allow the client (e.g., the STAs 704) to quickly and efficiently determine whether the update is applicable to the client and whether to read and process later portions (e.g., a late portion 730) of the frame 705 and other frames or communications. These techniques may reduce power and computing resource overhead associated with some critical update procedures.

For example, the first indication 710 of the frame 705 may identify whether the AP 702 belongs to a pre-UHR or a UHR or later generation, and the first indication 710 may be an example of a field (such as bit or a flag) that indicates whether the AP belongs to the pre-UHR or a UHR or later generation. The first indication 710 may be used by clients belong to UHR and later generations to follow the new indication scheme described herein. The flag may be indicative of generations other than UHR (e.g., pre-UHR within the scope of the present disclosure). The third indication 720 may identify the earliest generation to which an update to a parameter is applicable. The third indication 720 may allow the client to ignore the updates when the updates belong to a later generation and may reduce the quantity of clients that may poll the AP 702 to retrieve the updates. The scheme of the frame 705 may support backward compatibility while supporting reduced resource consumption as the scheme may avoid changing critical update signaling and mechanisms to retrieve the updates by the client. Additionally, these techniques may support uses of signaling schemes that may be ignored by pre-11bn clients.

The second indication 715, which may be used to indicate that there is an update to at least one parameter associated with a generation of the wireless network supported by the AP 702, may be an example of a critical updates flag (CUF) contained in a capability information field 735 in the early portion 725 of the frame 705. Thus, when a critical update is to occur on one or more links supported by the AP 702, until and including the next delivery traffic indication message (DTIM) beacon, the AP 702 may set the CUF (e.g., the second indication 715) to “1” to indicate that the critical update occurs on the one or more links. As described herein, the second indication 715 may indicate whether the AP 702 is a UHR or later generation AP (e.g., whether the update is applicable to UHR or later generation APs). In such cases, a later generation AP may also be considered a UHR AP.

Additionally, the third indication 720 may be an example of a field in the frame 705 that includes x number of bits with the ability to indicate up to 2^{x} generations (e.g., EHT and beyond). For example, for the third indication 720: a value of “0” indicates that the update is applicable to EHT/Wi-Fi7 clients, a value of “1” indicates that the update is applicable to UHR/Wi-Fi8 clients, a value of “2” indicates UHR+/Wi-Fi9, etc. The third indication 720 may be valid until and including the next DTIM beacon when a critical update occurs on any link. The third indication 720 may be included within frames until and including the next DTIM beacon so that STA that are expected to wake up and process the DTIM beacon receive the updates. In cases of updates to multiple generations, the third indication 720 indicates the earliest generation for which the update exists due to updates to earlier generations being applicable to STAs to later generations. For example, EHT updates may be applicable to UHR STAs. If the third indication 720 is 3 bits, then the third indication 720 may be used to indicate that the update is applicable to 8 different generations (e.g., that the AP is one of 8 generations). In some cases, the frame 705 includes a basic service set (BSS) parameters change count (BPCC) field (e.g., defined by EHT) that is link specific (e.g., included per link) and may be incremented for each critical update for any generation (e.g., including pre-UHR). The BPCC field may support a STA that misses an increment and receives a subsequent increment to probe the AP for the update to the link. That is, the BPCC is used to indicate changes in the broadcast parameters of a reported neighboring BSS and may be used to help clients track whether there have been changes in the broadcast configuration of neighboring APs.

The third indication 720 may also be in the form of a bitmap carried in two or more bits of a field of the frame 705. Each value of the bitmap may be mapped to a generation of for which the update may be applicable. the bitmap may include values set to “1” to indicate that the corresponding generation (e.g., a generation mapped to the bit) includes an update. Similarly, the first indication 710 (e.g., the indication of the generation of the AP 702) may be in the form of a bitmap, where each bit of the bitmap represents a generation supported by the AP.

In some cases, the clients (e.g., STAs 704) of the AP 702 may be configured to wake-up, process a portion of the beacon frame (e.g., up to a TIM element), then refrain from processing the remainder of the frame (e.g., enter a sleep mode) if the TIM element indicates that the beacon frame is not applicable to the client. In some cases, the clients may use an auxiliary radio to monitor the beacon frames up to the TIM element and activate the main radio of the TIM element indicates that the beacon frame is applicable to the clients. As such, the first indication 710, the second indication 715, and the third indication 720 being positioned within an early portion 725 of the frame 705 may allow the clients to make decisions quickly and efficiently and to determine whether to process (e.g., via main radio) other portions of the frame 705 (e.g., the late portion 730).

The use of the first indication 710 (e.g., UHR or later generation) and the third indication 720 (e.g., earliest generation with update) together may be useful for older generation clients (e.g., pre-UHR) make an early decision and because the older generation clients may not have the ability to process the third indication 720 (e.g., the generation update field). For example, if bit 2 (B2) of the capability information field 735 contains the first indication 710 and the third indication 720 is contained in one or more previously reserved bits (e.g., B3, B6, B7), then a pre-UHR STA may read B2 and quickly determine whether to read or process other portions of the beacon frame (e.g., late portion 830). Additionally, a UHR or later STA may read B2, then determine whether to process the third indication 720 contained in B3, B6, and B7, for example. As described elsewhere herein the indications of the frame 705 may be in other portions of the frame 705.

The following Table 1 illustrates examples of indications included in the frame 705:

TABLE 1

| CUF | UHR AP | Gen Update | Remark |
|---|---|---|---|
| 1 | 0 or 1 | 000 (0) | Update to pre-UHR parameters - |
| | | | follow EHT's critical updates |
| | | | mechanism |
| 1 | 1 | Nonzero | Updates to UHR or beyond - check |
| | | | Gen Update fields to determine the |
| | | | generation of the updates |

In Table 1, the CUF column corresponds to the second indication 715, the UHR AP column corresponds to the first indication 710, and the generation update (“Gen Update”) column corresponds to the third indication 720. Thus, the generation update field indicates the earliest generation (EHT and beyond) of the update across one or more impacted links. A client may be expected to retrieve updates belonging to the indicated generation and earlier generations. If the field is not applicable to the client, then the client may ignore the update in some cases. This technique allows the client to abort processing the frame if the update is for a later generation or a generation that to which the update is not applicable. As described herein, the BPCC may be incremented for all cases (UHR and beyond). The client determines which link(s) have an updated by parsing the BPCC fields (e.g., carried in a basic multi-link (ML) information element (IE) (basic ML IE) and a reduced neighbor report (RNR), as described in further detail herein). In some examples, a separate CUF and BPCC may be defined for UHR and beyond. Such an approach may support the EHT STAs saving power since the legacy CUF and BPCC may remain unchanged when there is an update to UHR or later.

In a first example of using the indications of the frame 705, the AP 702 is a Wi-Fi9 AP, and there is an update to the EHT parameters of the transmitting link. In this example, the CUF (e.g., the second indication 715) is set to “1,” the UHR AP field (e.g., the first indication 710) is set to “0,” the generation update field (e.g., the third indication 720) is set to “0,” the BPCC is incremented in the ML IE, and the BPCC in RNR for the other links is not incremented. In a second example, the AP 702 is a Wi-Fi8 AP, and there is an update to an EHT parameter of another link. In this example, the CUF is set to “1,” the UHR AP field is set to “1,” the generation update field is set to “0,” the BPCC is incremented in the RNR corresponding to the impacted link, and the BPCC in the basic ML IE is not incremented. In a third example, the AP is a Wi-Fi10 AP, and there is an update to the w Wi-Fi9 parameters in the transmitting link. In this example, the CUF is set to “1,” the UHR AP is set to “1,” the generation update is set to “2,” the BPCC in the basic ML IE is incremented, and the BPCC in RNR for the other links is not incremented. In a fourth example, the AP 702 is a Wi-Fi8 AP, and there is an update to the WiFI8 parameter of the other link. In this example, the CUF field is set to “1,” the UHR AP field is set to “1,” the generation update field is set to “1,” the BPCC in RNR corresponding to the impacted link is incremented, and the BPCC in the basic ML IE is not incremented.

The use of the BPCC in RNR may allow devices to quickly determine if they are to update their cached information about neighboring networks, which may supported reduced scanning and processing of unchanged parameters. Thus, there may be a first BPCC in the basic ML IE for the transmitting link and a second BPCC in RNR for other links (e.g., partner links), which may be transmitted per other link.

In some cases, instead of the generation update field (e.g., the third indication 720) including an indication of the earliest generation starting with EHT, the generation update field is used to indicate the earliest generation starting with UHR. In this example, the CUF (e.g., the second indication 715) may be applicable to EHT devices. Further, in this example, a value of “0” for the generation update field (e.g., all bits set to 0) indicates there are no updates for UHR or beyond generations, a value of “1,” may indicate UIR/Wi-Fi8 generation, a value of “2” may indicate Wi-Fi9, etc. Similar to the previous example use of the generation update field, when there are updates to multiple generations, the generation update field indicates the oldest generation for which the update exists due to older updates being applicable to later updates. This field is valid until and including the next DTIM beacon when a critical update occurs on one or more links. Additionally, an eBPCC field (e.g., the BSS parameters change counter defined by EHT) is link specific and is incremented each time there is an update for any generation (including pre-UHR). Additionally, a new uBPCC field (e.g., new BSS Parameters Change Counter) may be defined and may be link specific (e.g., a uBPCC field per link) and incremented each time there is an update for any generations UHR and beyond (e.g., above a threshold generation) on the link. The following Table 2 illustrates example operations using these types of parameters:

TABLE 2

| CUF | UHR | | Gen | | |
|---|---|---|---|---|---|
| (EHT) | AP | eBPCC | Update | uBPCC | Remark |
| 1 | 0 or 1 | ++ | 000 | No | Updates to pre-UHR |
| | | | | Change | parameters - follow |
| | | | | | EHT's critical updates |
| | | | | | mechanism (appropriate |
| | | | | | link's eBPCC gets |
| | | | | | incremented) |
| 0 | 1 | No | Nonzero | ++ | Updates to UHR or |
| | | change | | | beyond - check Gen |
| | | | | | Update fields to |
| | | | | | determine the generation |
| | | | | | of the updates. |
| | | | | | (appropriate link's |
| | | | | | uBPCC gets |
| | | | | | incremented) |

In the example of Table 2, since the legacy CUF is not set, the EHT STAs may not be woken-up when there is an update to UHR or higher generations. Additionally, the example of Table 2 utilizes the separate BPCCs. In the event when there is an update to EHT and UHR (++), then CUF, generation update, and BPCCs may be impacted. This technique may allow EHT stations to quickly determine whether there is an applicable update based on the CUF (e.g., the second indication 715) and wake-up (or not) accordingly. The uBPCC may be included in the basic ML IE, the RNR, or another type of element. Additionally, the uBPCC may be included for the transmitting link and neighboring link(s) (e.g., two or more instances of the uBPCC).

The following are examples of utilization of the indications of the frame 705 and use of two BPCC indications. In a first example, the AP 702 is a Wi-Fi9 AP, and there is an update to the EHT parameters of the transmitting link. In this example, the CUF (e.g., the second indication 715) is set to “1,” the UHR AP field (e.g., the first indication 710) is set to “0,” the generation update field (e.g., the third indication 720) is set to “0,” the BPCC is incremented in the ML IE, the BPCC in RNR for the other links is not incremented, and the uBPCC for any link is not incremented. In a second example, the AP 702 is a Wi-Fi8 AP, and there is an update to an EHT parameter of another link. In this example, the CUF is set to “1,” the UHR AP field is set to “1,” the generation update field is set to “0,” the BPCC is incremented in the RNR corresponding to the impacted link, the BPCC in the basic ML IE is not incremented, and the uBPCC for any link is not incremented. In a third example, the AP is a Wi-Fi10 AP, and there is an update to the w Wi-Fi9 parameters in the transmitting link. In this example, the CUF is set to “0,” the UHR AP is set to “1,” the generation update is set to “2,” the uBPCC in the basic ML IE is incremented, the uBPCC in RNR for the other links is not incremented, and the BPCC for any link is not incremented. In a fourth example, the AP 702 is a Wi-Fi8 AP, and there is an update to the Wi-Fi8 parameter of the other link. In this example, the CUF field is set to “0,” the UHR AP field is set to “1,” the generation update field is set to “1,” the uBPCC in RNR corresponding to the impacted link is incremented, the uBPCC in the basic ML IE is not incremented, and the BPCC for any link is not incremented.

In some cases, the frame 705 may contain two CUFs: an eCUF defined by EHT that is set to “1” when a critical update occurs on any link (e.g., until and including the next DTIM beacon) and a uCUF (e.g., second indication 715) defined by UHR that is set to “1” when a critical update occurs on any link (e.g., until and including the next DTIM beacon). The third indication 720 (e.g., generation update field) may be used similarly as described with other options described herein. The following Table 3 illustrates example operations using these two CUFs:

TABLE 3

| eCUF | UHR | uCUF | | | |
|---|---|---|---|---|---|
| (EHT) | (AP) | (UHR) | eBPCC | uBPCC | Remark |
| 1 | 0 or 1 | 0 | ++ | No | Updates to pre-UHR |
| | | | | Change | parameters - follow |
| | | | | | EHT's critical updates |
| | | | | | mechanism (appropriate |
| | | | | | link's eBPCC gets |
| | | | | | incremented) |
| 0 | 1 | 1 | No | ++ | Updates to UHR or |
| | | | Change | | beyond - check Gen |
| | | | | | Update fields to |
| | | | | | determine the gen of |
| | | | | | the updates. (appropriate |
| | | | | | link's uBPCC gets |
| | | | | | incremented) |

In the example of Table 3, since legacy CUF is not set (e.g., in the first row), EHT STAs may not be woken-up when there is an update to UHR or higher generations. Additionally, the separate BPCCs described with respect to Table 2 may be applicable. Moreover, when there is an update to EHT and UHR (++), then both CUFs, generation update, and BPCCs may be impacted.

Thus, various options for the indications included in the frame 705 are described herein. Additionally, various options for the locations of the indications are provided within the frame 705 are described herein. In cases when an AP 702 that has assigned transmitted BSS identifier (TxBSSID) or the AP 702 does not belong to a Multi-BSSID set (e.g., dot11MultBSSID=false), then various options signaling options for the indications may be available. As described, some client implementations may choose to abandon processing of the entire beacon if the clients determine that the AP does not have any critical updates that are applicable to the client and there are no DL buffered frames at the AP 702 for the client. That is, the STA may not receive and/or process the rest of the beacon frame after the TIM element. Therefore, as described herein, it may be beneficial to provide an indication of applicability of the updates in the early portion 725 of the frame 705 (e.g., the beacon frame). The signaling options detailed herein are provided in the early portion 725 of the beacon frame.

In one example, a bit (e.g., B2 which is previously reserved) in the capability information field 735 of the frame 705 may be used to indicate whether the AP 702 is a UHR AP (e.g., the first indication 710). In this example implementation, the B6 (CUF) and B7 (nonTxBSSID) may be preserved. In another example, a bit (e.g., B49) in the TIM element may be used to indicate whether the AP 702 is a UHR AP or not. In another example, a combination of bits (e.g., in the capability information field 735) may be used to indicate a generation of the AP 702. For example, one or more bits set to “1” means that the AP 702 is a UHR AP, one or more bits set to “2” means that the AP 702 is a Wi-Fi9 AP, the one or more bits set to “3” means that the Wi-Fi10 AP, etc. Thus, a set of bits may be used to indicate an generation of the AP 702.

For the generation update (e.g., the third indication 720), a set of bits may be used to indicate the earliest generation for which the update is applicable. For example, 3 bits (e.g., B3, B14, and B15) in the capability information field 735 may be used to indicate the generation update. In another example, a set of bits in the TIM element (e.g., B50, B51, and B52) may be used to indicate the earliest generation for which the update is applicable. Thus, the set of bits may function as or be configured as a virtual bitmap. In such cases, these bits may not be present in the partial bitmap when the bits are set to 0 and a compression technique (e.g., method B compression) is applied. However, subsequent bits may be used to indicate that the updates are applicable to other (later) generations. The set of bits may be fixed by the standards (e.g., B50, B51, and B52 or another set of two or more bits) or may be determined by the AP 702. For example, the AP 702 may determine the location of these bits and signal the location of these bits to the clients. In examples when the set of bits are included in a virtual bitmap (e.g., PV8 bits 2006 through 2008 include the generation update), the AP 702 may signal the location of the virtual bitmap. In cases when a bitmap is used, each value of the bitmap may correspond to a generation, and values of the bitmap may indicate a starting generation for which the update is applicable and an ending point for which the update is applicable. Additionally, the bitmap may include values set to “1” to indicate that the corresponding generation (e.g., a generation mapped to the bit) includes an update. In the example of using bits B50, B51, and B52, if the AP 702 is Wi-Fi10, then all three bits may be set to “1.” Similarly, if there is an update to Wi-Fi8 and Wifi9, then B50 and B51 may be set to “1,” and B52 may be set to “0.” These techniques are applicable to other bit set possibilities (e.g., B14 and B15).

In examples when the AP 702 is a UHR AP, meaning that the TxBSSID is a UHR ID, then the APs corresponding to non-transmitted BSSIDs (nonTxBSSIDs) are UHR APs, and as such, dedicated fields for UHR APs may not be used. That is, the multiple BSSID set may belong to the same generation of the TxBSSID. Thus, a STA 704 may determine the generation of the multiple BSSID set based on bit B2 of the capability information field 735 in the frame 705 of the TxBSSID (e.g., transmitted by AP 702). In such cases, 3 bits in the capability information field (e.g., B3, B14, and B15 or B2, B3, B7, etc.) within the non-transmitted BSSID capability element of the frame 705 may be used for indicating the generation.

As described herein, some techniques may propose UHR and later generation APs to not include one or more elements defined by UHR and later generations in the beacon frame. The omitted elements may then be obtained via probing or during association. However, such as scheme may lead to probe storm, where multiple STAs poll the AP to retrieve a critical update.

Various options may be considered to alleviate probe storm, and a combination of these options may be used. In a first option, the AP 702 may include, within the frame 705, the UHR and later elements that encounter an update during a critical update. For example, a field (e.g., “Updates included field”) may be used to signal the inclusion of the updates within the frame 705. The field may be carried in the early portion 725 of the frame 705, such as the capability information field 735 or the TIM. This technique may be applicable when the updates apply to the transmitting AP (e.g., the transmitted BSSID in a multiple BSSID set). For an AP corresponding to a nontransmitted BSSID, the indication (i.e., updates included field) may be carried in the non-transmitted BSSID capability element. These options may be dependent on the deployment scenario. For example, in enterprise scenarios, there may be many APs and the frame size may be too large (e.g., due to multiple links, resulting in multiple link profiles in the frame). However, in home scenarios, frame size may not be an issue and these techniques may be used for the signaling techniques described herein. Thus, these techniques may be applicable based on beacon frame size, which may be dependent on deployment scenarios.

In one or more additional options for retrieving updates, a UHR AP (e.g., the AP 702) may transmit a broadcast frame that provides the updates after transmitting the indications as described herein. The frame that carries the updates may be a probe response frame or another type of frame. The frame carrying the updates may carry only the updated element. In some cases, the frame may be sent in UHR PPDU format so that legacy STAs may ignore the frame. Additionally, or alternatively, the frame may be a new frame defined by UHR (e.g., a “UHR Update Notification Frame”), which may be carried in UHR PPDU. Additionally, or alternatively, a field (e.g., Unsolicited Updates Broadcast) may indicate the presence of a follow-up frame carrying the update. The field may be carried in the early portion 725 of the frame 705 (e.g., the beacon frame), such as in one or more bits of the capability information field 735.

In one or more additional options for retrieving the updates, the UHR AP (e.g., the AP 702) may transmit a broadcast response when it receives a query to retrieve the updates. This technique may suppress queries from other non-APs that are attempting to retrieve the updates. In such cases, the standards may define one or more rules specifying that a client is not to send a query for a designated (e.g., defined) time if the AP advertises the updates. For example, the AP 702 advertises the update according to techniques described herein, and the STA 704-a transmits a probe or query, then the other STAs 704-a may suppress their respective probes or queries and receive the frame carrying the update in response to the probe or query transmitted by the STA 704-a. The options described herein for retrieving the update may be dependent on the operating conditions. For example, if the network is too crowded, then the AP 702 may decide to not send the update frame until a probe is received from one or more STAs 704.

In some cases, the AP 702 may designate a link for a client (e.g., STA 704) to send a query frame such as to spread or limit query storm. That is, different clients may be assigned to different links. The query links may be identified and/or assigned during an association phase and/or may be modified by the AP 702 at a later time (e.g., based on conditions of the network). In cases where an update is not applicable to a STA 704, the client may locally increment the sum of the BPCC values for each link. This technique may be used because the client may not be aware of the link that encountered the update and thus may not be able to identify a particular BPCC value.

As discussed previously, a UHR AP (e.g., the AP 702) may not include each of the UHR defined elements (e.g., UHR Operations element) in the beacon frame that is transmitted. However, there may be scenarios where the beacon size is not too large (e.g., non-multi-BSS case and/or home deployments), and a UHR AP may be able to fit each of the elements in the beacon frame. In such cases, the AP may provide an indication of whether the beacon is complete or not. The field (e.g., “Beacon Complete” field) may be carried in the early portion 725 of the frame 705, such as in one or more of the bits of the capability information field 735. A similar field may be included within the non-transmitted BSSID profile sub-element for a nonTxBSSID to indicate the completeness of the profile. The field (e.g., “Profile Complete” field) may be carried in the early portion of the profile, such as the capability information field within the NonTxBSSID capability information.

In addition to the in-BSS critical updates procedure, UHR may define a field (e.g., CAP Update field) to indicate an update to one or more coordinated access point (CAP) procedures or features (e.g., multi-AP coordination procedures) that may be relevant to another AP (e.g., a coordinating AP). The field may include a single bit to indicate an update to a CAP procedure. Additionally, or alternatively, a bitmap may be used, and each value of the bitmap may correspond to a respective CAP feature (such as c-TDMA, C-SR, C-BF, c-RTWT etc.) to indicate an update to the respective CAP feature. The CAP update field may be carried in the early portion 725 of the frame 705, such as in a field of the partial virtual bitmap of the TIM element or a field in the Capability Information field. The AP that receives the CAP update indication from the neighboring/coordinating AP may retrieve the updates via querying the signaling AP or by listening for a broadcast CAP notification in the frame carrying the updates. Considerations related to unsolicited broadcast vs. polling described herein may be applicable to the CAP update scenarios.

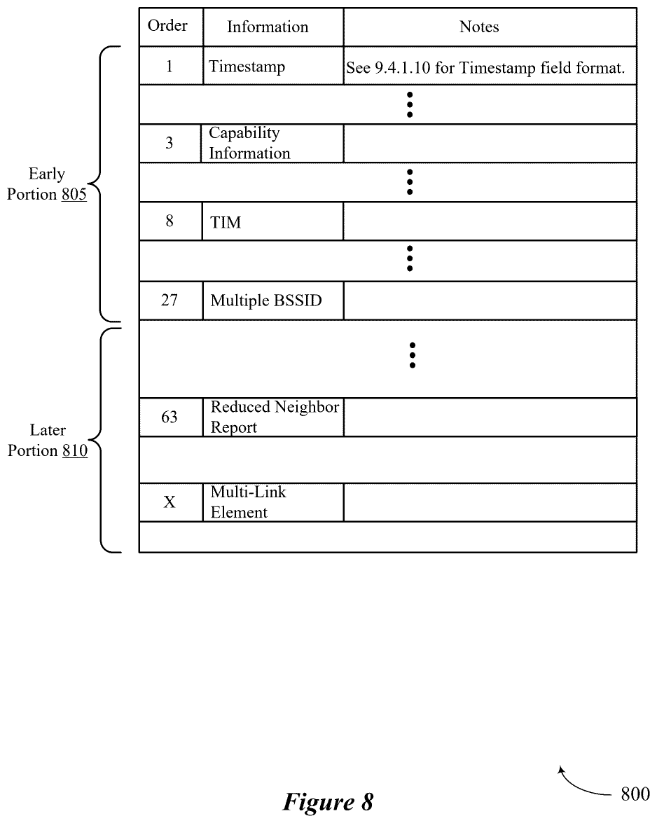

FIG. 8 shows an example of a frame body 800 that supports techniques to indicate updates to wireless parameters. The frame body 800 may be implemented by an AP as described with respect to FIGS. 1 through 7 to indicate updates to wireless parameters to other STAs or APs as described with respect to FIGS. 1 through 7.

For example, an AP 702 may transmit the frame body 800 that includes one or more indications, such as the first indication 710 (e.g., UHR AP), the second indication 715 (e.g., CUF), a third indication 720 (e.g., generation update), in addition to other indication as described herein, via one or more information elements of the frame body 800. More particularly, the update indications may be transmitted via one or more information elements of an early portion 805 of the frame body 800, which contains a later portion 810.

In one non-limiting example, the early portion of the frame body 800 contains information elements in order 1 through 27, while information element in order 28 and later are in the later portion 810 of the frame body 800. As described herein, including the update indications in the early portion 805 of the frame body may support a client (e.g., STAs 704) quickly and efficiently being able to determine whether an update is applicable client. In cases when the update is not applicable to the client, the client may refrain from receiving or processing some information of the frame body 800, such as at least at least a subset of information elements in the later portion 810.

As described herein, the UHR AP or EHT AP indication may be carried in a bit in the capability information element (e.g., order 3) of the early portion 805 of the frame body 800. For example, bit B2 may carry the indication that the transmitting AP is a pre-UHR AP or a UHR or later AP, such that a receiving client is able to quickly determine whether to process later portions of update information (e.g., the generation update indication, information associated with the update). Additionally, as described herein, the generation update indication (e.g., the third indication 720), which may specify the earliest generation to which the update is applicable or a set of generations to which the update is applicable, may be carried in two or more bits of the capability information field (e.g., order 3), two or more bits in the TIM information element (e.g., order 8), or a combination thereof. Additionally, the CUF (e.g., the second indication 715), which may indicate that an update is available for any generation, may be carried in the TIM information element.

As described herein, some indications may be link specific, and in such cases, various bits of the multiple BSSID information element (e.g., order 27) may be used for link-specific indications, such as the generation update for a link. Additionally, as multiple links may be present, each link may be indicated via a respective multiple BSSID information element. The generation update may be carried in a capability information element within the multiple BSSID information element.

Further, the BPCC fields described herein may be carried in one or more information elements in the frame body 800. For example, the transmitting link BPCC field may be located in the multi-link element (e.g., basic multi-link element within the multi-link element) of the later portion 810 of the frame body 800. Neighboring link BPCC fields may be located in the reduced neighbor report (e.g., order 63) of the frame. As described herein, these fields may be used to indicate updates and used by STAs to determine whether the STAs are configured with the latest updates (e.g., whether an update was missed).

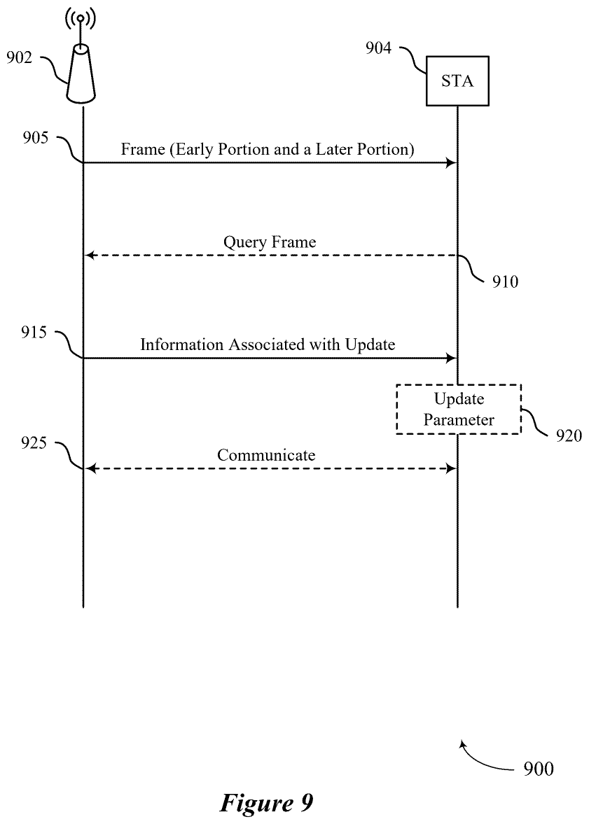

FIG. 9 shows an example of a process flow 900 that supports techniques to indicate updates to wireless parameters. The process flow 900 includes an AP 902 and a STA 904, which may be examples of the corresponding devices described herein with respect to FIGS. 1 through 8.

Alternative examples of the following may be implemented, where some operations are performed in a different order than described or are not performed at all. In some examples, operations may include additional features not mentioned below, or further operations may be added. Although the AP 902 and the STA 904 are shown performing the operations of the process flow 900, some aspects of some operations may also be performed by one or more other components.

At 905, the AP 902 outputs, and the STA 904 obtains a frame that includes an early portion. The early portion of the frame includes a first indication of a first generation of a wireless network implemented by an access point associated with the frame, a second indication that there is an update to at least one first parameter associated with at least one generation of the wireless network, and a third indication of at least an earliest generation that has at least one updated parameter, the earliest generation associated with the wireless network. The first indication may be an example of an indication of whether the AP 902 is a UHR or later AP or a pre-UHR AP. The second indication may be a CUF that indicates that an update is available for one or more generations. The third indication may be an example of the generation update that indicates the earliest generation for which the update is applicable or indicates one or more generations for which the update is applicable.

In some examples, the first the first indication is included in a capability information field of the frame, and/or the third indication is included in the capability information field of the frame. The first indication may be included in a bit B2 of the capability information field, and/or the third indication may be included in bits B3, B14, or B15 of the capability information field. In some examples, the first indication is included in a TIM field of the frame, and/or the third indication is included in the TIM field of the frame. The frame may be an example of beacon frame, and/or the third indication may be included in bits b50, b51, or B52 in the TIM map field.

In some examples, the early portion of the frame further includes a fourth indication (e.g., a uCUF for UHR) that there is a second update to a second parameter associated with a second generation of the wireless network, where the second generation satisfies a threshold (e.g., Wi-Fi8 and later generations). The information may further include a fifth indication (e.g., uBPCC) of a parameter change count associated with the second generation, and the fifth indication may be included in a later portion of the frame that follows the early portion.

In some cases, the information includes a fourth indication of a parameter change count (e.g., uBPCC) associated with a second generation of the wireless network, where the second generation satisfies a threshold (e.g., UHR/Wi-Fi8 and later generations). The fourth indication may be included in a later portion of the frame that follows the early portion. Additionally, or alternatively, a second update to a second parameter associated with the second generation is signaled using non-zero values to the first indication and the fourth indication. For example, the generation update field may include one or more non-zero bits signaling an indication of an update to UHR and later generations.

In some examples, the first indication is associated with the access point associated with a TxBSSID. Additionally, or alternatively, the information may include a fourth indication of a second generation of the wireless network that has at least one updated parameter associated with a second access point associated with a nonTxBSSID, where the second generation satisfies a threshold. In such cases, the fourth indication may be conveyed via three bits in a nontransmitted BSSID capability element (e.g., capability information in the nontransmitted BSSID element).

In some cases, the early portion of the frame includes TIM field and fields that are positioned before the TIM field in the frame. The frame may be configured as a beacon frame. In some cases, the at least one first parameter (e.g., the updated parameter) is a BSS parameter. In some cases, the at least one parameter is associated with a second generation of the wireless network, where the second generation satisfies a threshold.

At 910, the STA 904 may output and the AP may obtain a query frame (e.g., after the frame is output by the AP 902 and obtained by the STA 904).

At 915, the STA 904 may obtain, based at least in part on the third indication, information associated with the update to the at least one first parameter. In some cases, the information is included in the frame that includes the first indication, the second indication, and the third indication. The information may be included in a second frame different than the frame. For example, the second frame (e.g., a response frame, a probe response frame) may be output by the AP 902 and obtained by the STA 904 in response to the query frame (e.g., probe request frame) output and obtained at 910. Additionally, or alternatively, the second frame may be output by the AP 902 without obtaining the query frame. The response frame may be a PPDU format associated with a second generation of the wireless network, where the second generation satisfies a threshold. For example, the response frame may be a UHR PPDU format frame. The query frame may be output by the STA 904 and obtained by the AP 902 using a link indicated or assigned by the AP 902.

At 920, the STA 904 may update the at least one updated parameter included in the third indication after obtaining the third indication. At 925, the STA 904 and the AP 902 may communicate based on the updated parameter.

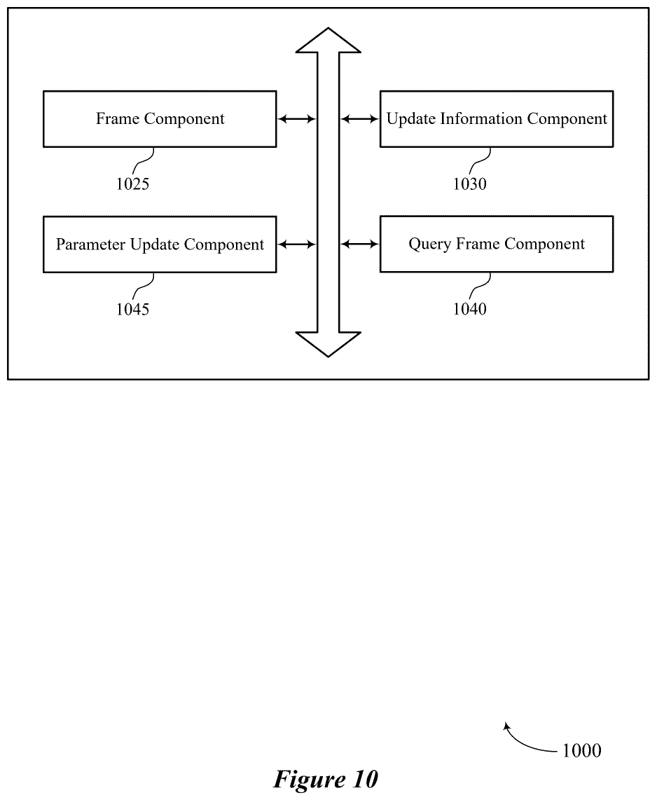

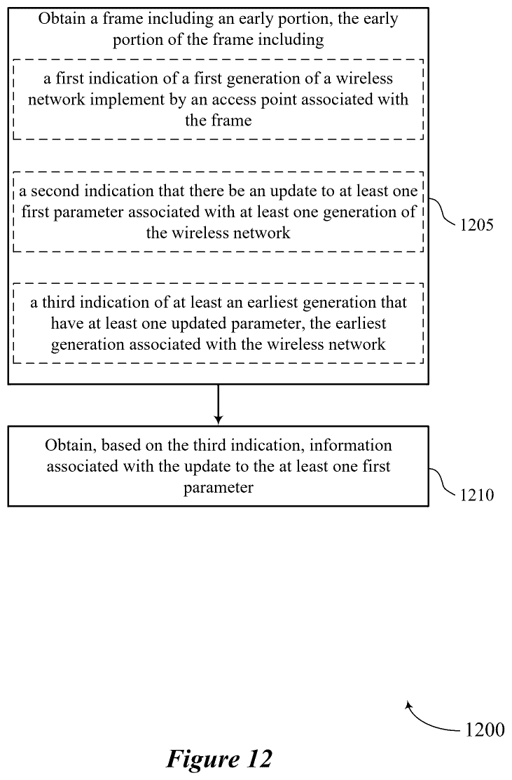

FIG. 10 shows a block diagram of an example wireless communication device 1000 that supports techniques to indicate updates to wireless parameters. In some examples, the wireless communication device 1000 is configured to perform the process 1200 described with reference to FIG. 12. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

Further, various components of the wireless communication device 1000 may provide means for performing the methods described herein. In some examples, means for transmitting and/or receiving may include the transceivers and/or antenna(s) of the wireless communication device 1000. In some examples, means for outputting or sending (such as means for outputting for transmission) and means for obtaining (such as means for obtaining after information is received from a different device) may include one or more interfaces of the wireless communication device 1000 to output signals to other components or obtain signals from other components of the wireless communication device 1000. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. The means for updating includes a processing system, processor circuitry (including one or more processors), memory circuitry, and/or computer-readable media of the wireless communication device 1000.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a frame component 1025, an update information component 1030, a query frame component 1040, and a parameter update component 1045. Portions of one or more of the frame component 1025, the update information component 1030, the query frame component 1040, and the parameter update component 1045 may be implemented at least in part in hardware or firmware. For example, one or more of the frame component 1025, the update information component 1030, the query frame component 1040, and the parameter update component 1045 may be implemented at least in part by at least a processor or a modem. In some examples, portions of one or more of the frame component 1025, the update information component 1030, the query frame component 1040, and the parameter update component 1045 may be implemented at least in part by a processor and software in the form of processor-executable code stored in memory.

The wireless communication device 1000 may support wireless communications in accordance with examples as disclosed herein. The frame component 1025 is configurable or configured to obtain a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network. The update information component 1030 is configurable or configured to obtain, based on the third indication, information associated with the update to the at least one first parameter.

In some examples, the first indication is included in a capability information field of the frame. In some examples, the third indication is included in the capability information field of the frame.

In some examples, the first indication is included in bit B2 of the capability information field. In some examples, the third indication is included in bits B3, B14, or B15 in the capability information field.

In some examples, the first indication is included in a traffic indication map field of the frame. In some examples, the third indication is included in the traffic indication map field of the frame.

In some examples, the frame includes a beacon frame. In some examples, the third indication is included in bits B50, B51, or B52 in the traffic indication map field.

In some examples, the early portion of the frame further includes a fourth indication that there is a second update to a second parameter associated with a second generation of the wireless network, the second generation satisfying a threshold. In some examples, the information further includes a fifth indication of a parameter change count associated with the second generation, the fifth indication being included in a later portion of the frame that follows the early portion.

In some examples, the information further includes a fourth indication of a parameter change count associated with a second generation of the wireless network, the second generation satisfying a threshold, the fourth indication being included in a later portion of the frame that follows the early portion. In some examples, each of the first indication and the fourth indication includes a non-zero value to indicate a.

In some examples, the first indication is associated with a transmitted basic service set identifier (TxBSSID).

In some examples, the information further includes a fourth indication of a second generation of the wireless network that has at least one updated parameter associated with a second access point associated with a non-transmitted basic service set identifier (nonTxBSSID), the second generation satisfying a threshold.

In some examples, the fourth indication is conveyed via three bits in a non-transmitted basic service set identifier capability element.

In some examples, the information is included in the frame.

In some examples, the early portion of the frame further includes a fourth indication that one or more updated parameters are included in the frame.

In some examples, the information is included in a second frame different than the frame.

In some examples, the query frame component 1040 is configurable or configured to output a query frame after obtaining the frame, where the information is obtained via a response frame and after outputting the query frame.

In some examples, the query frame includes a probe request frame. In some examples, the response frame includes a probe response frame.

In some examples, the response frame includes a physical layer protocol data unit format associated with a second generation of the wireless network, the second generation satisfying a threshold.

In some examples, the query frame is output via a link indicated by the access point.

In some examples, the early portion of the frame includes a traffic indication map field and fields that come before the traffic indication map field.

In some examples, the frame is configured as a beacon frame.

In some examples, the at least one first parameter is as a basic service set (BSS) parameter.

In some examples, the at least one first parameter is associated with a second generation of the wireless network, the second generation satisfying a threshold.

In some examples, the parameter update component 1045 is configurable or configured to update the at least one updated parameter included in the third indication after obtaining the third indication.

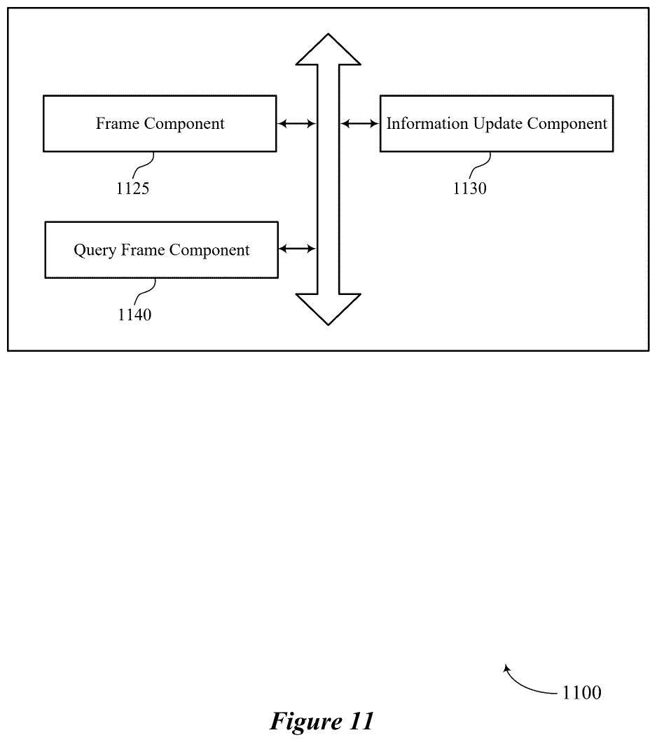

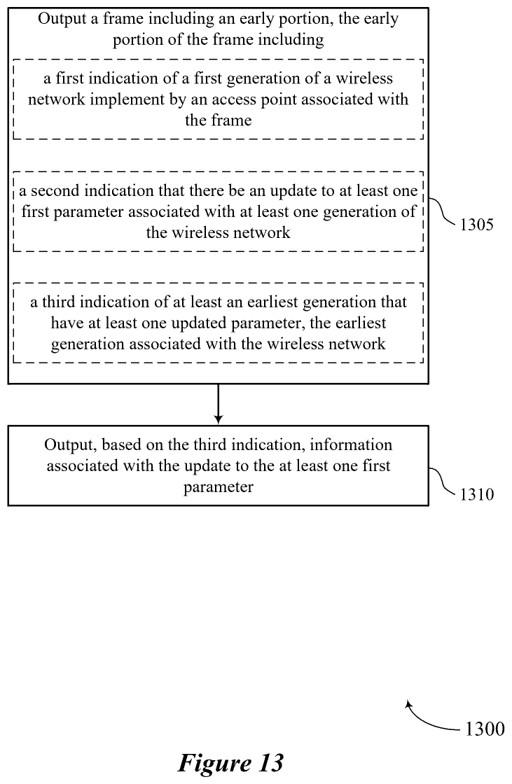

FIG. 11 shows a block diagram of an example wireless communication device 1100 that supports techniques to indicate updates to wireless parameters. In some examples, the wireless communication device 1100 is configured to perform the process 1300 described with reference to FIG. 13. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a frame component 1125, an information update component 1130, and a query frame component 1140. Portions of one or more of the frame component 1125, the information update component 1130, and the query frame component 1140 may be implemented at least in part in hardware or firmware. For example, one or more of the frame component 1125, the information update component 1130, and the query frame component 1140 may be implemented at least in part by at least a processor or a modem. In some examples, portions of one or more of the frame component 1125, the information update component 1130, and the query frame component 1140 may be implemented at least in part by a processor and software in the form of processor-executable code stored in memory.

The wireless communication device 1100 may support wireless communications in accordance with examples as disclosed herein. The frame component 1125 is configurable or configured to output a frame including an early portion, the early portion of the frame including a first indication of a first generation of a wireless network implemented by an access point associated with the frame, a second indication that there is an update to at least one first parameter associated with at least one generation of the wireless network, and a third indication of at least an earliest generation that has at least one updated parameter, the earliest generation associated with the wireless network. The information update component 1130 is configurable or configured to output, based on the third indication, information associated with the update to the at least one first parameter.

In some examples, the first indication is included in a capability information field of the frame. In some examples, the third indication is included in the capability information field of the frame.

In some examples, the first indication is included in bit B2 of the capability information field. In some examples, the third indication is included in bits B3, B14, or B15 in the capability information field.

In some examples, the first indication is included in a traffic indication map field of the frame. In some examples, the third indication is included in the traffic indication map field of the frame.

In some examples, the frame includes a beacon frame. In some examples, the third indication is included in bits B50, B51, or B52 in the traffic indication map field.

In some examples, the early portion of the frame further includes a fourth indication that there is a second update to a second parameter associated with a second generation of the wireless network, the second generation satisfying a threshold. In some examples, the information further includes a fifth indication of a parameter change count associated with the second generation, the fifth indication being included in a later portion of the frame that follows the early portion.

In some examples, the information further includes a fourth indication of a parameter change count associated with a second generation of the wireless network, the second generation satisfying a threshold, the fourth indication being included in a later portion of the frame that follows the early portion. In some examples, each of the first indication and the fourth indication includes a non-zero value to indicate a.

In some examples, the first indication is associated with t a transmitted basic service set identifier (TxBSSID).

In some examples, the information further includes a fourth indication of a second generation of the wireless network that has at least one updated parameter associated with a second access point associated with a non-transmitted basic service set identifier (nonTxBSSID), the second generation satisfying a threshold.

In some examples, the fourth indication is conveyed via three bits in a nontransmitted BSSID capability element.

In some examples, the information is included in the frame.

In some examples, the early portion of the frame further includes a fourth indication that one or more updated parameters are included in the frame.

In some examples, the information is included in a second frame different than the frame.

In some examples, the query frame component 1140 is configurable or configured to obtain a query frame after outputting the frame, where the information is output via a response frame and after obtaining the query frame.

In some examples, the query frame includes a probe request frame. In some examples, the response frame includes a probe response frame.

In some examples, the response frame includes a physical layer protocol data unit (PPDU) format associated with a second generation of the wireless network, the second generation satisfying a threshold.

In some examples, the query frame is output via a link indicated by the access point.

In some examples, the early portion of the frame includes a traffic indication map field and fields that come before the traffic indication map field.

In some examples, the frame is configured as a beacon frame.

In some examples, the at least one first parameter is as a basic service set (BSS) parameter.

In some examples, the at least one first parameter is associated with a second generation of the wireless network, the second generation satisfying a threshold.

FIG. 12 shows a flowchart illustrating an example process 1200 performable by or at an apparatus that supports techniques to indicate updates to wireless parameters. The operations of the process 1200 may be implemented by an apparatus or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1205, the apparatus may obtain a frame including an early portion, the early portion of the frame including a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network. The operations of 1205 may be performed in accordance with examples as disclosed herein. In some implementations, aspects of the operations of 1205 may be performed by a frame component 1025 as described with reference to FIG. 10.

In some examples, in 1210, the apparatus may obtain, based on the third indication, information associated with the update to the at least one first parameter. The operations of 1210 may be performed in accordance with examples as disclosed herein. In some implementations, aspects of the operations of 1210 may be performed by an update information component 1030 as described with reference to FIG. 10.

FIG. 13 shows a flowchart illustrating an example process 1300 performable by or at an apparatus that supports techniques to indicate updates to wireless parameters. The operations of the process 1300 may be implemented by an apparatus or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the apparatus may output a frame including an early portion, the early portion of the frame including a first indication of a first generation of a wireless network implemented by an access point associated with the frame, a second indication that there is an update to at least one first parameter associated with at least one generation of the wireless network, and a third indication of at least an earliest generation that has at least one updated parameter, the earliest generation associated with the wireless network. The operations of 1305 may be performed in accordance with examples as disclosed herein. In some implementations, aspects of the operations of 1305 may be performed by a frame component 1125 as described with reference to FIG. 11.

In some examples, in 1310, the apparatus may output, based on the third indication, information associated with the update to the at least one first parameter. The operations of 1310 may be performed in accordance with examples as disclosed herein. In some implementations, aspects of the operations of 1310 may be performed by an information update component 1130 as described with reference to FIG. 11.

Implementation examples are described in the following numbered clauses:

Aspect 1: A method for wireless communications at wireless node, comprising: obtaining a frame comprising an early portion, the early portion of the frame comprising a first indication of a first generation of a wireless network implemented by an access point associated with the frame, a second indication that there is an update to at least one first parameter associated with at least one generation of the wireless network, a third indication of at least an earliest generation that has at least one updated parameter, the earliest generation associated with the wireless network; and obtaining, based at least in part on the third indication, information associated with the update to the at least one first parameter.

Aspect 2: The method of aspect 1, wherein at least one of the first indication is included in a capability information field of the frame, or the third indication is included in the capability information field of the frame.

Aspect 3: The method of aspect 2, wherein at least one of the first indication is included in bit B2 of the capability information field, or the third indication is included in bits B3, B14, or B15 in the capability information field.

Aspect 4: The method of any of aspects 1 through 3, wherein at least one of the first indication is included in a traffic indication map field of the frame, or the third indication is included in the traffic indication map field of the frame.

Aspect 5: The method of aspect 4, wherein at least one of the frame comprises a beacon frame, or the third indication is included in bits B50, B51, or B52 in the traffic indication map field.

Aspect 6: The method of any of aspects 1 through 5, wherein at least one of the early portion of the frame further comprises a fourth indication that there is a second update to a second parameter associated with a second generation of the wireless network, the second generation satisfying a threshold, or the information further comprises a fifth indication of a parameter change count associated with the second generation, the fifth indication being included in a later portion of the frame that follows the early portion.

Aspect 7: The method of any of aspects 1 through 6, wherein at least one of the information further comprises a fourth indication of a parameter change count associated with a second generation of the wireless network, the second generation satisfying a threshold, the fourth indication being included in a later portion of the frame that follows the early portion, or each of the first indication and the fourth indication includes a non-zero value to indicate a.

Aspect 8: The method of any of aspects 1 through 7, wherein the first indication is associated with a transmitted basic service set identifier.

Aspect 9: The method of any of aspects 1 through 8, wherein the information further comprises a fourth indication of a second generation of the wireless network that has at least one updated parameter associated with a second access point associated with a non-transmitted basic service set identifier, the second generation satisfying a threshold.

Aspect 10: The method of aspect 9, wherein the fourth indication is conveyed via three bits in a nontransmitted BSSID capability element.

Aspect 11: The method of any of aspects 1 through 10, wherein the information is included in the frame.

Aspect 12: The method of any of aspects 1 through 11, wherein the early portion of the frame further comprises a fourth indication that one or more updated parameters are included in the frame.

Aspect 13: The method of any of aspects 1 through 12, wherein the information is included in a second frame different than the frame.

Aspect 14: The method of any of aspects 1 through 13, further comprising: outputting a query frame after obtaining the frame, wherein the information is obtained via a response frame and after outputting the query frame.

Aspect 15: The method of aspect 14, wherein the query frame comprises a probe request frame, or the response frame comprises a probe response frame.

Aspect 16: The method of any of aspects 14 through 15, wherein the response frame comprises a physical layer protocol data unit format associated with a second generation of the wireless network, the second generation satisfying a threshold.

Aspect 17: The method of any of aspects 14 through 16, wherein the query frame is output via a link indicated by the access point.

Aspect 18: The method of any of aspects 1 through 17, wherein the early portion of the frame comprises a traffic indication map field and other fields that come before the traffic indication map field.

Aspect 19: The method of any of aspects 1 through 18, wherein the frame is configured as a beacon frame.

Aspect 20: The method of any of aspects 1 through 19, wherein the at least one first parameter is as a basic service set parameter.

Aspect 21: The method of any of aspects 1 through 20, wherein the at least one first parameter is associated with a second generation of the wireless network, the second generation satisfying a threshold.

Aspect 22: The method of any of aspects 1 through 21, further comprising: updating the at least one updated parameter included in the third indication after obtaining the third indication.

Aspect 23: A method for wireless communications at wireless node, comprising: outputting a frame comprising an early portion, the early portion of the frame comprising a first indication of a first generation of a wireless network implemented by an apparatus, a second indication that there is an update to at least one first parameter associated with at least one generation of the wireless network, and a third indication of at least an earliest generation that has at least one updated parameter, the earliest generation associated with the wireless network; and outputting, based at least in part on the third indication, information associated with the update to the at least one first parameter.

Aspect 24: The method of aspect 23, wherein at least one of the first indication is included in a capability information field of the frame, or the third indication is included in the capability information field of the frame.

Aspect 25: The method of aspect 24, wherein at least one of the first indication is included in bit B2 of the capability information field, or the third indication is included in bits B3, B14, or B15 in the capability information field.

Aspect 26: The method of any of aspects 23 through 25, wherein at least one of the first indication is included in a traffic indication map field of the frame, or the third indication is included in the traffic indication map field of the frame.

Aspect 27: The method of aspect 26, wherein at least one of the frame comprises a beacon frame, or the third indication is included in bits B50, B51, or B52 in the traffic indication map field.

Aspect 28: The method of any of aspects 23 through 27, wherein at least one of the early portion of the frame further comprises a fourth indication that there is a second update to a second parameter associated with a second generation of the wireless network, the second generation satisfying a threshold, or the information further comprises a fifth indication of a parameter change count associated with the second generation, the fifth indication being included in a later portion of the frame that follows the early portion.

Aspect 29: The method of any of aspects 23 through 28, wherein at least one of the information further comprises a fourth indication of a parameter change count associated with a second generation of the wireless network, the second generation satisfying a threshold, the fourth indication being included in a later portion of the frame that follows the early portion, or each of the first indication and the fourth indication includes a non-zero value to indicate a.

Aspect 30: The method of any of aspects 23 through 29, wherein the first indication is associated with the apparatus associated with a transmitted basic service set identifier (TxBSSID).

Aspect 31: The method of any of aspects 23 through 30, wherein the information further comprises a fourth indication of a second generation of the wireless network that has at least one updated parameter associated with a second apparatus associated with a non-transmitted basic service set identifier (nonTxBSSID), the second generation satisfying a threshold.

Aspect 32: The method of aspect 31, wherein the fourth indication is conveyed via three bits in a nontransmitted BSSID capability element.

Aspect 33: The method of any of aspects 23 through 32, wherein the information is included in the frame.

Aspect 34: The method of any of aspects 23 through 33, wherein the early portion of the frame further comprises a fourth indication that one or more updated parameters are included in the frame.

Aspect 35: The method of any of aspects 23 through 34, wherein the information is included in a second frame different than the frame.

Aspect 36: The method of any of aspects 23 through 35, further comprising: obtaining a query frame after outputting the frame, wherein the information is output via a response frame and after obtaining the query frame.

Aspect 37: The method of aspect 36, wherein the query frame comprises a probe request frame, or the response frame comprises a probe response frame.

Aspect 38: The method of any of aspects 36 through 37, wherein the response frame comprises a physical layer protocol data unit (PPDU) format associated with a second generation of the wireless network, the second generation satisfying a threshold.

Aspect 39: The method of any of aspects 36 through 38, wherein the query frame is obtained via a link.

Aspect 40: The method of any of aspects 23 through 39, wherein the early portion of the frame comprises a traffic indication map field and fields that come before the traffic indication map field.

Aspect 41: The method of any of aspects 23 through 40, wherein the frame is configured as a beacon frame.

Aspect 42: The method of any of aspects 23 through 41, wherein the at least one first parameter is as a basic service set parameter.

Aspect 43: The method of any of aspects 23 through 42, wherein the at least one first parameter is associated with a second generation of the wireless network, the second generation satisfying a threshold.

Aspect 44: An apparatus for wireless communications, comprising one or more processing systems that include processor circuitry and memory circuitry that stores code, the one or more processing systems configured to cause the apparatus to perform the method of any of aspects 1 through 22.

Aspect 45: A wireless node (e.g., a station), including one or more transceivers, and one or more processing systems that includes processor circuitry and memory circuitry that stores code, the one or more processing systems configured to cause the wireless node to perform the method of any of aspects 1 through 22, wherein the one or more transceivers are configured to receive the frame and receive the information associated with the update.

Aspect 46: An apparatus for wireless communications, comprising at least one means for performing the method of any of aspects 1 through 22.

Aspect 47: A non-transitory computer-readable medium storing code for wireless communications, the code comprising instructions executable by one or more processing systems to perform the method of any of aspects 1 through 22.

Aspect 48: An apparatus for wireless communications, comprising one or more processing systems that include processor circuitry and memory circuitry that stores code, the one or more processing systems configured to cause the apparatus to perform the method of any of aspects 23 through 43.

Aspect 49: A wireless node (e.g., an access point), including one or more transceivers, and one or more processing systems that include processor circuitry and memory circuitry that stores code, the one or more processing systems configured to cause the wireless node to the method of any of aspects 23 through 43, wherein the one or more transceivers are configured to transmit the frame and transmit the information associated with the update.

Aspect 50: An apparatus for wireless communications, comprising at least one means for performing the method of any of aspects 23 through 43.

Aspect 51: A non-transitory computer-readable medium storing code for wireless communications, the code comprising instructions executable by one or more processing systems to perform the method of any of aspects 23 through 43.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications, comprising:
one or more processing systems that include processor circuitry and memory circuitry that stores code, the one or more processing systems configured to cause the apparatus to:
obtain a frame comprising an early portion, the early portion of the frame comprising:
a first indication of a first generation of a wireless network implemented by an access point associated with the frame;
a second indication that there is an update to at least one first parameter associated with at least one generation of the wireless network; and
a third indication of at least an earliest generation that has at least one updated parameter, the earliest generation associated with the wireless network; and
obtain, based at least in part on the third indication, information associated with the update to the at least one first parameter.

2. The apparatus of claim 1, wherein at least one of:
the first indication is included in a capability information field of the frame; or
the third indication is included in the capability information field of the frame.

3. The apparatus of claim 2, wherein at least one of:
the first indication is included in bit B2 of the capability information field, or
the third indication is included in bits B3, B14, or B15 in the capability information field.

4. The apparatus of claim 1, wherein at least one of:
the first indication is included in a traffic indication map field of the frame; or
the third indication is included in the traffic indication map field of the frame.

5. The apparatus of claim 4, wherein at least one of:
the frame comprises a beacon frame; or
the third indication is included in bits B50, B51, or B52 in the traffic indication map field.

6. The apparatus of claim 1, wherein at least one of:
the early portion of the frame further comprises a fourth indication that there is a second update to a second parameter associated with a second generation of the wireless network, the second generation satisfying a threshold; or
the information further comprises a fifth indication of a parameter change count associated with the second generation, the fifth indication being included in a later portion of the frame that follows the early portion.

7. The apparatus of claim 1, wherein at least one of:
the information further comprises a fourth indication of a parameter change count associated with a second generation of the wireless network, the second generation satisfying a threshold, the fourth indication being included in a later portion of the frame that follows the early portion; or
each of the first indication and the fourth indication comprise a non-zero value to indicate a second update to a second parameter associated with the second generation.

8. The apparatus of claim 1, wherein the first indication is associated with a transmitted basic service set identifier (TxBSSID).

9. The apparatus of claim 1, wherein the information further comprises a fourth indication of a second generation of the wireless network that has at least one updated parameter associated with a second access point associated with a non-transmitted basic service set identifier (nonTxBSSID), the second generation satisfying a threshold.

10. The apparatus of claim 9, wherein the fourth indication is conveyed via three bits in a non-transmitted basic service set identifier capability element.

11. The apparatus of claim 1, wherein at least one of:
the information is included in the frame;
the early portion of the frame further comprises a fourth indication that one or more updated parameters are included in the frame;
the early portion of the frame comprises a traffic indication map field and other fields that come before the traffic indication map field;
the frame comprises a beacon frame;
the at least one first parameter is as a basic service set (BSS) parameter; or
the at least one first parameter is associated with a second generation of the wireless network, the second generation satisfying a threshold.

12. The apparatus of claim 1, wherein the information is included in a second frame different than the frame.

13. The apparatus of claim 1, wherein the one or more processing systems are further configured to cause the apparatus to:
output a query frame after obtaining the frame, wherein the information is obtained via a response frame and after outputting the query frame.

14. The apparatus of claim 13, wherein:
the query frame comprises a probe request frame; or
the response frame comprises a probe response frame.

15. The apparatus of claim 13, wherein the response frame comprises a physical layer protocol data unit (PPDU) format associated with a second generation of the wireless network, the second generation satisfying a threshold.

16. The apparatus of claim 13, wherein the query frame is output via a link indicated by the access point.

17. The apparatus of claim 1, wherein the one or more processing systems are further configured to cause the apparatus to:
update the at least one updated parameter included in the third indication after obtaining the third indication.

18. The apparatus of claim 1, further comprising:
one or more transceivers configured to receive the frame and the information, wherein the apparatus is configured as a station.

19. An apparatus for wireless communications, comprising:
one or more processing systems that include processor circuitry and memory circuitry that stores code, the one or more processing systems configured to cause the apparatus to:
output a frame comprising an early portion, the early portion of the frame comprising:
a first indication of a first generation of a wireless network implemented by the apparatus;
a second indication that there is an update to at least one first parameter associated with at least one generation of the wireless network; and
a third indication of at least an earliest generation that has at least one updated parameter, the earliest generation associated with the wireless network; and
output, based at least in part on the third indication, information associated with the update to the at least one first parameter.

20. The apparatus of claim 19, wherein at least one of:
the first indication is included in a capability information field of the frame; or
the third indication is included in the capability information field of the frame.

21. The apparatus of claim 20, wherein at least one of:
the first indication is included in bit B2 of the capability information field, or
the third indication is included in bits B3, B14, or B15 in the capability information field.

22. The apparatus of claim 19, wherein at least one of:
the first indication is included in a traffic indication map field of the frame; or
the third indication is included in the traffic indication map field of the frame.

23. The apparatus of claim 19, further comprising:
one or more transceivers configured to transmit the frame and the information, wherein the apparatus is configured as an access point.

24. A method for wireless communications at a wireless node, comprising:
obtaining a frame comprising an early portion, the early portion of the frame comprising:
a first indication of a first generation of a wireless network implemented by an access point associated with the frame;
a second indication that there is an update to at least one first parameter associated with at least one generation of the wireless network; and
a third indication of at least an earliest generation that has at least one updated parameter, the earliest generation associated with the wireless network; and
obtaining, based at least in part on the third indication, information associated with the update to the at least one first parameter.
